(19) United States
(12) Patent Application Publication
(10) Pub. No.: US 2021/0118445 A1
(43) Pub. Date: Apr. 22, 2021

(54) METHOD AND APPARATUS FOR MANAGING COMMUNICATION TO PERFORM ACTION

(71) Applicant: Samsung Electronics Co., Ltd., Gyeonggi-do (KR)

(72) Inventor: Abhishek CHOURASIYA, Jaipur (IN)

(21) Appl. No.: 16/475,969

(22) PCT Filed: Jan. 5, 2018
(86) PCT No.: PCT/KR2018/000281

§ 371 Date: Jul. 3, 2019

(30) Foreign Application Priority Data
Jan. 5, 2017 (IN) 201741000517

(51) Int. Cl. G10L 15/26; G06F 16/242; G06F 16/2452; G06F 9/451; G06F 3/16; G06F 40/174

(52) U.S. Cl. CPC G10L 15/26; G06F 16/243; G06F 16/24522; G10L 2015/223; G06F 3/167; G06F 40/174; G06F 9/453

(57) ABSTRACT

Embodiments herein provide a method for managing an action of an electronic device. The method includes obtaining a structural query generated based on a natural language query including at least one parameter. Further, the method includes retrieving at least one result corresponding to the structural query from the at least one information source. Further, the method includes selecting a result from the at least one result. Further, the method includes performing an action corresponding to the selected result as a response to the natural language query.

### TECHNICAL FIELD

The embodiments herein generally relate to electronic devices. More particularly related to a method for managing communication with an electronic device to automatically perform actions based on query generation.

### BACKGROUND ART

With increasing use of electronic devices, a steep increase in usage for performing various activities of the user using the electronic device has been observed. The user of the electronic device is provided with different options to perform various activities such as calling, messaging, email, finding locations, booking online orders, etc. For the ease of performing the various activities, voice-based communication techniques has been integrated in the electronic devices. In a conventional voice-based communication, the user can provide a query to retrieve the information available in the electronic device. Generally, the response provided by the conventional voice-based communication techniques is either too many or too few. The user has to manually perform various operations to achieve the desired response.

Moreover, the response from the conventional communication techniques does not automatically perform the actual activity desired by the user. For example, calling a person, whose contact number is not available in the electronic device, composing a specific message and sending to a specific number of a person, filling the desired information in a form and submitting to a service provider etc. Thus, there is need in the art to provide a communication system to automatically perform user desired activities.

### DISCLOSURE OF INVENTION

### Solution to Problem

Accordingly the embodiments herein provide a method for managing an action of an electronic device. The method includes receiving, by the electronic device, a natural language query including a plurality of parameters. Further, the method includes retrieving, by the electronic device, a plurality of results corresponding to the natural language query from at least one information source. Further, the method includes selecting, by the electronic device, a candidate result from the plurality of results based on a degree of relevance. Further, the method includes performing, by the electronic device, an action corresponding to the candidate result as a response to the natural language query.

### Advantageous Effects of Invention

The principal aspect of the embodiments herein is to provide a method and electronic device thereof for managing communication to perform action. Another aspect of the embodiments herein is to provide a method for receiving a natural language query including a plurality of parameters. Another aspect of the embodiments herein is to provide a method for retrieving a plurality of results corresponding to the natural language query from at least one information source. Another aspect of the embodiments herein is to provide a method for selecting a candidate result from the plurality of results based on a degree of relevance. Another aspect of the embodiments herein is to provide a method for performing an action corresponding to the candidate result as a response to the natural language query.

Yet another aspect of the embodiments herein is to provide a method for generating a structural query based on the natural language query including the plurality of parameters. Yet another aspect of the embodiments herein is to provide a method for generating a modified structural query by adjusting at least one parameter from the plurality of parameters if at least one result corresponding to the structural query is not received from the at least one information source. Yet another aspect of the embodiments herein is to provide a method for retrieving a result corresponding to the modified structural query from the at least one information source.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a system for managing communication to perform an action by an electronic device, according to an embodiment as disclosed herein;

FIG. 2 illustrates various units of an electronic device, according to an embodiment as disclosed herein;

FIG. 3 illustrates various units of a query engine, according to an embodiment as disclosed herein;

FIG. 4 illustrates various units of a server, according to an embodiment as disclosed herein;

FIG. 5a is an example sequence diagram related to a method for selecting a relevant contact information by a server, according to an embodiment as disclosed herein;

FIG. 5b is an example sequence diagram related to a method for selecting a relevant contact information by an electronic device, according to an embodiment as disclosed herein;

FIG. 6 is a flow chart illustrating an operation method for an electronic device, according to an embodiment as disclosed herein;

FIG. 7 is a flow chart illustrating an operation method for an electronic device, according to an embodiment as disclosed herein;

FIG. 8 is a flow chart illustrating an operation method for a server, according to an embodiment as disclosed herein;

FIG. 9 is a flow chart illustrating an operation method for a server, according to an embodiment as disclosed herein;

FIG. 10 illustrates an example scenario for an electronic device performing an action as a response to a natural language query, according to an embodiment as disclosed herein;

FIGS. 11a-11c illustrate an example scenario for a process of an electronic device to perform an action as a response to a natural language query, according to an embodiment as disclosed herein;

FIGS. 12a-12c illustrate an example scenario for a process of an electronic device to perform an action as a response to a natural language query, according to an embodiment as disclosed herein;

FIGS. 13a-13c illustrate an example scenario for a process of an electronic device to perform an action as a response to a natural language query, according to an embodiment as disclosed herein;

FIGS. 14a-14c illustrate an example scenario for a process of an electronic device to perform an action as a response to a natural language query, according to an embodiment as disclosed herein;

FIG. 15 illustrates an example scenario for an electronic device performing an action as a response to a natural language query, according to an embodiment as disclosed herein;

FIG. 16 illustrates an example scenario for an electronic device performing an action as a response to a natural language query, according to an embodiment as disclosed herein;

FIG. 17 illustrates an example scenario for an electronic device performing an action as a response to a natural language query, according to an embodiment as disclosed herein;

FIG. 18 illustrates an example scenario where the proposed method allows user to get connected to at least one service provider when stuck in an emergency situation, according to an embodiment as disclosed herein;

FIG. 19 is an example scenario for an electronic device set a reminder a response to a natural language query, according to an embodiment as disclosed herein; and

FIG. 20 illustrates a computing environment implementing a method for managing communication to perform an action by an electronic device, according to an embodiment as disclosed herein.

### BEST MODE FOR CARRYING OUT THE INVENTION

Accordingly the embodiments herein provide a method for managing an action of an electronic device. The method includes receiving, by the electronic device, a natural language query including a plurality of parameters. Further, the method includes retrieving, by the electronic device, a plurality of results corresponding to the natural language query from at least one information source. Further, the method includes selecting, by the electronic device, a candidate result from the plurality of results based on a degree of relevance. Further, the method includes performing, by the electronic device, an action corresponding to the candidate result as a response to the natural language query.

In an embodiment, the degree of relevance is dynamically defined based on at least one of the plurality of parameters, a current location of the electronic device, learning model, and context information. In an embodiment, performing the action includes one of opening an application, filling data in an application, terminating an application, composing a message, sending a message, displaying the candidate result, initiating a communication service, terminating a communication service, and updating a service. In an embodiment, the action includes a series of actions performed as a response to the natural language query. In an embodiment, the series of actions is determined based on the plurality of parameters. In an embodiment, the plurality of parameters includes at least one subject, at least one object and an action to be performed corresponding to at least one of the at least one subject and the at least one object. In an embodiment, the at least one subject includes a desired location, a communication service request, an action to be performed, a price, a user rating, an availability of a communication service, a satisfaction level of the user, congestion, throughput, latency, and a user defined parameter. In an embodiment, the at least one object includes a desired location, a communication service request, an action to be performed, a price, a user rating, an availability of a communication service, a satisfaction level of the user, congestion, throughput, latency, and a user defined parameter. In an embodiment, the candidate result is one of a contact item, a service, an application, a message identifier, a web site address, a phone number, an e-mail identifier, a geographical address, a geographical location, and a SNS (Social Networking Site) identifier.

In an embodiment, retrieving the plurality of results corresponding to the natural language query from the at least one information source includes extracting the plurality of parameters, generating a structural query based on at least one parameter from the plurality of parameters, sending the structural query to the at least one information source, and receiving the plurality of results as a response to the structural query from the at least one information source.

Accordingly the embodiments herein provide a method for managing an action of an electronic device. The method includes receiving, by the electronic device, a natural language query including a plurality of parameters. Further, the method includes generating, by the electronic device, a structural query based on the natural language query. Further, the method includes receiving, by the electronic device, at least one result corresponding to the structural query from at least one information source. Further, the method includes generating, by the electronic device, a modified structural query by adjusting at least one parameter from the plurality of parameters if at least one result corresponding to the structural query is not received from the at least one information source or if a plurality of results corresponding to the structural query are received from the information source. Further, the method includes retrieving, by the electronic device, a result corresponding to the modified structural query from the at least one information source. Further, the method includes performing, by the electronic device, an action corresponding to the result as a response to the natural language query.

Accordingly the embodiment herein is to provide a method for managing an action of an electronic device. The method includes receiving, by a server, a structural query including a plurality of parameters. Further, the method includes retrieving, by the server, a plurality of results corresponding to the structural query from at least one information source. Further, the method includes selecting, by the server, a candidate result from the plurality of results based on a degree of relevance. Further, the method includes sending, by the server, the candidate result to the electronic device to perform an action corresponding to the candidate result.

Accordingly the embodiments herein provide a method for managing an action of an electronic device. The method includes receiving, by a server, a structural query comprising a plurality of parameters. Further, the method includes receiving, by the server, at least one result corresponding to the structural query from at least one information source. Further, the method includes generating, by the server, a modified structural query by adjusting at least one parameter from the plurality of parameters if at least one result corresponding to the structural query is not received from the at least one information source or if a plurality of results corresponding to the structural query are received from the information source. Further, the method includes retrieving, by the server, a result corresponding to the modified structural query from the at least one information source. Further, the method includes sending, by the server, the result to the electronic device to perform an action corresponding to the result.

Accordingly the embodiments herein provide an electronic device for performing an action. The electronic device includes a memory unit, a controller unit, coupled to the memory unit, and a query engine configured to receive a natural language query including a plurality of parameters. Further, the query engine configured to retrieve a plurality of results corresponding to the natural language query from at least one information source. Further, the query engine configured to select a candidate result from the plurality of results based on a degree of relevance. Further, the query engine configured to perform an action corresponding to the candidate result as a response to the natural language query.

Accordingly the embodiments herein provide an electronic device for preforming an action. The electronic device includes a memory unit, a controller unit, coupled to the memory unit, and a query engine configured to receive a natural language query including a plurality of parameters. Further, the query engine configured to receive at least one result corresponding to the natural language query from at least one information source. Further, the query engine configured to generate a modified structural query by adjusting at least one parameter from the plurality of parameters if at least one result corresponding to the natural language query is not received from the at least one information source or if a plurality of results corresponding to the structural query are received from the information source. Further, the query engine configured to retrieve a result corresponding to the modified structural query from the at least one information source. Further, the query engine configured to perform an action corresponding to the result as a response to the modified structural query.

Accordingly the embodiments herein provide a server for managing an action of an electronic device. The server includes a memory unit, a controller unit, coupled to the memory unit, and a query engine configured to receive a structural query including a plurality of parameters. Further, the query engine is configured to retrieve a plurality of results corresponding to the structural query from at least one information source. Further, the query engine is configured to select a candidate result from the plurality of results based on a degree of relevance. Further, the query engine is configured to send the candidate result to the electronic device to perform an action corresponding to the candidate result.

Accordingly the embodiments herein provide a server for managing an action of an electronic device. The server includes a memory unit, a controller unit, coupled to the memory unit, and a query engine configured to receive a structural query including a plurality of parameters. Further, the query engine is configured to receive at least one result corresponding to the structural query from at least one information source. Further, the query engine is configured to generate a modified structural query by adjusting at least one parameter from the plurality of parameters if at least one result corresponding to the structural query is not received from the at least one information source or if a plurality of results corresponding to the structural query are received from the information source. Further, the query engine is configured to retrieve a result corresponding to the modified structural query from the at least one information source. Further, the query engine is configured to send the result to the electronic device to perform an action corresponding to the result.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness. Also, the various embodiments described herein are not necessarily mutually exclusive, as some embodiments can be combined with one or more other embodiments to form new embodiments. Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments herein provide a method for managing an action of an electronic device. The method includes receiving a natural language query including a plurality of parameters. Further, the method includes generating a structural query based on the natural language query. Further, the method includes retrieving a plurality of results corresponding to the structural query from at least one information source. Further, the method includes selecting a candidate result from the plurality of results based on a degree of relevance. Further, the method includes performing an action corresponding to the candidate result as a response to the natural language query.

Another embodiment herein provides a method for managing an action of an electronic device. The method includes receiving the natural language query including the plurality of parameters. Further, the method includes generating a structural query based on the natural language query. Further, the method includes receiving at least one result corresponding to the structural query is received from the at least one information source. Further, the method includes generating a modified structural query by adjusting at least one parameter from the plurality of parameters if at least one result corresponding to the natural language query is not received from the at least one information source or if a plurality of results corresponding to the structural query are received from the information source. Further, the method includes retrieving a result corresponding to the modified structural query from the at least one information source. Further, the method includes performing an action corresponding to the result as a response to the natural language query.

Another embodiment herein provides a method for an action of an electronic device. The method includes receiving, by a server, a structural query including a plurality of parameters. Further, the method includes retrieving, by the server, a plurality of results corresponding to the structural query from at least one information source. Further, the method includes selecting, by the server, a candidate result from the plurality of results based on a degree of relevance. Further, the method includes sending, by the server, the candidate result to the electronic device to perform an action corresponding to the candidate result.

Another embodiment herein provides a method for managing an action of an electronic device. The method includes receiving, by a server, a structural query including the plurality of parameters. Further, the method includes receiving, by the server, at least one result corresponding to the structural query from at least one information source. Further, the method includes generating, by the server, a modified structural query by adjusting at least one parameter from the plurality of parameters if at least one result corresponding to the structural query is not received from the at least one information source or if a plurality of results corresponding to the structural query are received from the information source. Further, the method includes retrieving, by the server, a result corresponding to the modified structural query from the at least one information source. Further, the method includes sending, by the server, the result to the electronic device to perform an action corresponding to the result.

Another embodiment herein provides a method for managing an action of an electronic device. The method comprising, obtaining a structural query generated based on a natural language query including at least one parameter, sending the structural query to at least one information source, retrieving at least one result corresponding to the structural query from the at least one information source, selecting a result from the at least one result and performing an action corresponding to the selected result as a response to the natural language query.

Another embodiment herein the method further comprising, receiving the natural language query including the at least one parameter from a user, extracting the at least one parameter from the natural language query, and generating the structural query based on the extracted at least one parameter.

Another embodiment herein, wherein the at least one result comprises at least one service provider, and wherein selecting the result comprises selecting a service provider among the at least one result based on a service type included in the structural query and selecting a contact information, as the result, among at least one contact of the selected service provider based on an action type included in the structural query.

Another embodiment herein, wherein the service provider is selected further based on at least one filter included in the structural query.

Another embodiment herein the method further comprising adjusting the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

Another embodiment herein, wherein the action comprises one of opening an application, filling data in an application, terminating an application, composing a message, sending a message, displaying the candidate result, initiating a communication service, terminating a communication service, and updating a service.

Another embodiment herein, wherein the at least one parameter comprises at least one of a desired location, a communication service request, a required action type, a required service type, a price, a user rating, an availability of a communication service, a satisfaction level of the user, congestion, throughput, latency, and a user defined parameter.

Another embodiment herein, wherein the selected result is one of a contact item, a service, an application, a message identifier, a web site address, a phone number, an e-mail identifier, a geographical address, a geographical location, and a social networking site (SNS) identifier.

Another embodiment herein an electronic device comprising a memory unit and a controller unit coupled to the memory unit and configured to obtain a structural query generated based on a natural language query including at least one parameter, send the structural query to at least one information source, retrieve at least one result corresponding to the structural query from the at least one information source, select a result from the at least one result and perform an action corresponding to the selected result as a response to the natural language query.

Another embodiment herein the controller unit further configured to receive the natural language query including the at least one parameter from a user, extract the at least one parameter from the natural language query, and generate the structural query based on the extracted at least one parameter.

Another embodiment herein, wherein the at least one result comprises at least one service provider, and wherein the controller unit further configured to select the result by selecting a service provider among the at least one result based on a service type included in the structural query and selecting a contact information, as the result, among at least one contact of the selected service provider based on an action type included in the structural query.

Another embodiment herein, wherein the service provider is selected further based on at least one filter included in the structural query.

Another embodiment herein the controller unit further configured to adjust the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

Another embodiment herein, wherein the action comprises one of opening an application, filling data in an application, terminating an application, composing a message, sending a message, displaying the candidate result, initiating a communication service, terminating a communication service, and updating a service.

Another embodiment herein, wherein the at least one parameter comprises at least one of a desired location, a communication service request, a required action type, a required service type, a price, a user rating, an availability of a communication service, a satisfaction level of the user, congestion, throughput, latency, and a user defined parameter.

Another embodiment herein, wherein the selected result is one of a contact item, a service, an application, a message identifier, a web site address, a phone number, an e-mail identifier, a geographical address, a geographical location, and a social networking site (SNS) identifier.

Another embodiment herein provides a method for providing information by a server. The method comprising, obtaining a structural query generated based on a natural language query including at least one parameter, retrieving at least one result corresponding to the structural query from the at least one information source, selecting a result from the at least one result and transmitting the selected result for an electronic device to perform an action corresponding to the selected result as a response to the natural language query.

Another embodiment herein, wherein the at least one result comprises at least one service provider, and wherein selecting the result comprises selecting a service provider among the at least one result based on a service type included in the structural query and selecting a contact information, as the result, among at least one contact of the selected service provider based on an action type included in the structural query.

Another embodiment herein, wherein the service provider is selected further based on at least one filter included in the structural query.

Another embodiment herein the method further comprising adjusting the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

Another embodiment herein, wherein the action comprises one of opening an application, filling data in an application, terminating an application, composing a message, sending a message, displaying the candidate result, initiating a communication service, terminating a communication service, and updating a service.

Another embodiment herein, wherein the at least one parameter comprises at least one of a desired location, a communication service request, a required action type, a required service type, a price, a user rating, an availability of a communication service, a satisfaction level of the user, congestion, throughput, latency, and a user defined parameter.

Another embodiment herein, wherein the selected result is one of a contact item, a service, an application, a message identifier, a web site address, a phone number, an e-mail identifier, a geographical address, a geographical location, and a social networking site (SNS) identifier.

Another embodiment herein an server comprising a memory unit and a controller unit coupled to the memory unit and configured to obtain a structural query generated based on a natural language query including at least one parameter, retrieve at least one result corresponding to the structural query from the at least one information source, select a result from the at least one result and transmit the selected result for an electronic device to perform an action corresponding to the selected result as a response to the natural language query.

Another embodiment herein, wherein the at least one result comprises at least one service provider, and wherein the controller unit further configured to select the result by selecting a service provider among the at least one result based on a service type included in the structural query and selecting a contact information, as the result, among at least one contact of the selected service provider based on an action type included in the structural query.

Another embodiment herein, wherein the service provider is selected further based on at least one filter included in the structural query.

Another embodiment herein the controller unit further configured to adjust the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

Another embodiment herein, wherein the action comprises one of opening an application, filling data in an application, terminating an application, composing a message, sending a message, displaying the candidate result, initiating a communication service, terminating a communication service, and updating a service.

Another embodiment herein, wherein the at least one parameter comprises at least one of a desired location, a communication service request, a required action type, a required service type, a price, a user rating, an availability of a communication service, a satisfaction level of the user, congestion, throughput, latency, and a user defined parameter.

Another embodiment herein, wherein the selected result is one of a contact item, a service, an application, a message identifier, a web site address, a phone number, an e-mail identifier, a geographical address, a geographical location, and a social networking site (SNS) identifier.

Unlike conventional systems and methods, the proposed method can be used for intelligent execution of actions based on automatic query generation. Initially, a user input (or natural language query) is received including an operation type and a service type along with additional parameters (if any) through a voice command or the user can enter manually using a key pad. After receiving the input, a database (i.e., information source) query is generated using the user input and parameters for searching contact information (i.e., a candidate result). Until most relevant contact information is detected, automatic zoning (i.e., zone extension or reduction) for query is performed (i.e., adjusting the at least one parameter from the plurality of parameters to generate the modified structural query). Further, the user specified action is automatically executed using the most relevant contact information of the retrieved contact.

Further, the proposed method is used to intelligently and automatically perform the actions with respect to user specified service which is nearest to the location of the electronic device or the user. This allows the electronic device to easily perform the actions such as calling, messaging, form filling, or the like without actually worrying for the availability of the contact information for required type of service at required location with required parameters. The parameters can include the price, the user rating, the availability of the communication service, the satisfaction level of the user, or any other user defined parameters.

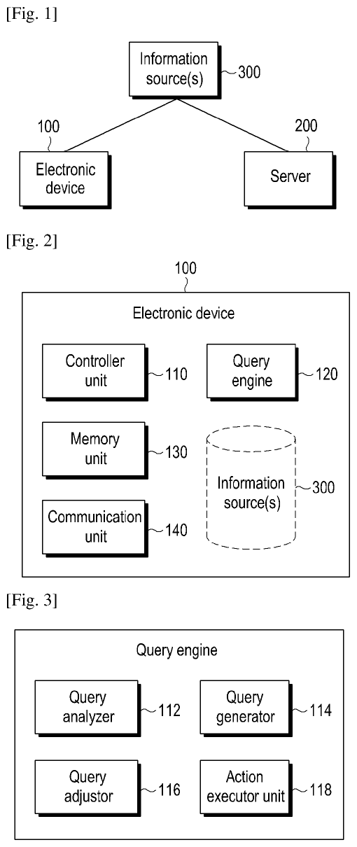

Referring now to the drawings, and more particularly to FIGS. 1 through 20, where similar reference characters denote corresponding features consistently throughout the figures, there are shown preferred embodiments.

FIG. 1 illustrates a system for managing communication to perform an action by an electronic device, according to an embodiment as disclosed herein. In an embodiment, the system includes the electronic device 100, a server 200, and the information source(s) 300. In an embodiment, the information source 300 can be within the server 200. In another embodiment, the information source 300 can be within the electronic device 100. The electronic device 100 can be, for example but not limited to, a mobile phone, a smart phone, PDAs (Personal Digital Assistants), a tablet, a phablet, a consumer electronic device, or any other electronic device.

Initially, a user provides a voice input, a text input, or a natural language query to the electronic device 100. After receiving the voice input, the electronic device 100 can be configured to analyze the voice input to extract a plurality of parameters (or a set of user desired parameters). Based on the extraction, the electronic device 100 can be configured to generate a structural query based on at least one parameter from the plurality parameters. Further, the electronic device 100 can be configured to send the structural query to the information source 300. The structural query is sent to the information source 300 for retrieving a plurality of results (or a set of user desired results) from the information source 300. After receiving the structural query, the server 200 can be configured to retrieve the plurality of results corresponding to the structural query from the information source 300. Further, the server 200 can be configured to select a candidate result from the plurality of results based on a degree of relevance. In an embodiment, the degree of relevance is dynamically defined based on at least one of the plurality of parameters, a current location of the electronic device 100, and context information. In an example, consider scenario where two or more candidate results are equidistant to the location of the electronic device 100. From the two or more candidate results, only one candidate result is selected based on the context information such as user history, user profile, user preferences, etc. After selecting the candidate result, the server 200 can be configured to send the candidate result to the electronic device 100. The electronic device 100 can be configured to perform the action corresponding to the candidate result as a response to the natural language query.

In another embodiment, after generating the structural query, the electronic device 100 can be configured to send the structural query to the information source 300 in the server 200. After receiving the structural query, the server 200 can be configured to receive at least one result corresponding to the natural language query from the information source 300. Further, the server 200 can be configured to adjust the structural query by adjusting (i.e., removing or changing) at least one parameter from the plurality of parameters if the at least one result corresponding to the natural language query is not received from the information source 300. Further, the server 200 can be configured to retrieve a result corresponding to the adjusted structural query from the information source 300. After retrieving the result, the server 200 can be configured to send the result to electronic device 100. The electronic device 100 can be configured to perform the action corresponding to the result as a response to the structural query.

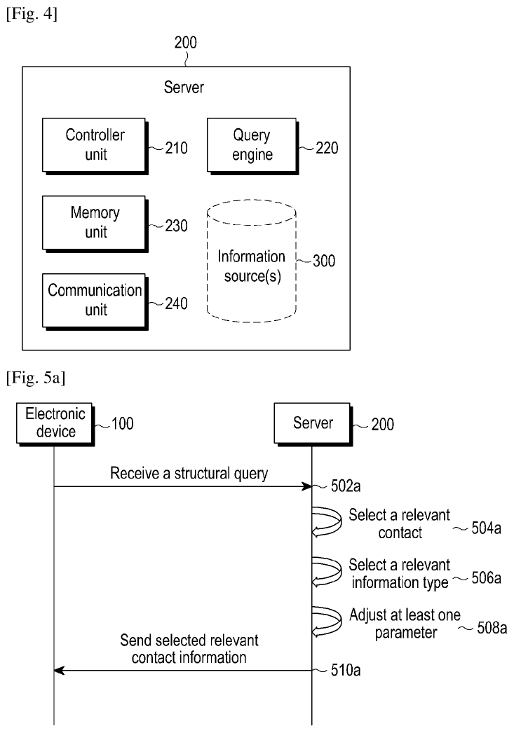

In another embodiment, the information source 300 can be within the electronic device 100 and the functionalities performed by the server 200 can be performed by the electronic device 100 as explained in conjunction with the FIG. 1. Further, the additional functionalities of the electronic device 100 are explained in conjunction with FIG. 2. Further, the functionalities of the server 200 are explained in conjunction with FIG. 4. In an embodiment, the information source 300 includes information related to one or more services such as contact number, website address, address of the service, availability, a user rating, etc. In an embodiment, the user can specify following filters (i.e., at least one subject and at least one object) such as a desired location, a communication service request, a user rating, a price, and an availability of a communication service while providing the natural language query. Further, such filters can be added to the natural language query by the user according to which the structural query is generated by the electronic device 100. The electronic device 100 filters out the plurality of results (i.e., candidate service providers) on the basis of these filters. In an example, consider a scenario in which the user provides the natural language query “Save Electrician, Logix Cyber Park, Available”. The user provides following voice input with the pause in between the parameters i.e.,

Save <pause> Electrician <pause> Logix Cyber Park <pause> Available

In this scenario, the electronic device 100 searches for the service type “Electrician” near to the area “Logix Cyber Park” whose availability status (i.e., filter) is “Available”. Thus, the contact information of the following service provider is automatically stored in the electronic device 100. However, if the user had not specified any filter of “Availability”, the service providers which are in “Logix Cyber Park” and near to the electronic device 100 are recommended.

In conventional systems, the user faces following problems as described below:

1. No method to automatically perform actions (or operations) such as sending an email, sending a message, saving the contact information, automatic form filling, placing an order, enabling Wi-Fi services, etc.

2. No method to perform actions with desired location parameters such as a location of the electronic device or any other specific location.

3. No method to perform actions with further additional parameters such as rating, price, availability of communication service, etc.

4. No method for extracting only relevant information (or only a single candidate result) corresponding to the action type for the relevant contact.

There is a need for a system which allows intelligent execution of actions by automatically retrieving the contact information based on user specified parameters related to the location etc. Unlike conventional systems and methods, the proposed method provides the user with solutions to above problems as it offers the user:

1. To automatically perform various actions such as calling, messaging, etc.

2. To perform actions corresponding to the service provider which is in proximity to the location of the electronic device or to any other user desired location.

3. To filter the service providers based on other parameters such as the user rating, the satisfaction level of the user, availability of the communication service, the price, etc.

Further, the proposed method can be used to provide one or more options to the user:

1. To specify the action such as calling, e-mail, message, save, order etc. using a voice command or a text command.

2. To provide the emergency service types such as police, ambulance, restaurant, pizza place, plumber etc. using the voice command or the text command.

3. To provide additional location preference or further filtering parameters, if any, using the voice command.

The FIG. 1 shows the system 100 but it is to be understood that other embodiments are not limited thereon. In other embodiments, the system 100 may include less or more number of units. Further, the labels or names of the units are used only for illustrative purpose and does not limit the scope of the invention. One or more units can be combined together to perform same or substantially similar function in the system 100.

FIG. 2 illustrates various units of an electronic device, according to an embodiment as disclosed herein. In an embodiment, the electronic device 100 includes at least one of a controller unit 110, a query engine 120, a memory unit 130, a communication unit 140, and the information source(s) 300. In an embodiment, the information source(s) 300 can be omitted and can be within a server. In an embodiment, the controller unit 110 can perform the functionalities of the query engine 120 as described below without departing from the scope of the invention. Further, the controller unit 110 can be configured to control the system and method flow. Further, the controller unit 110 can include an audio unit (not shown) to control activities related to audio such as audio recording etc. The query engine 120 can be configured to receive the natural language query including the plurality of parameters. In an embodiment, the plurality of parameters includes at least one subject, at least one object and the action to be performed corresponding to at least one of the at least one subject and the at least one object. The at least one subject and the at least one object includes a desired location, a communication service request, an action to be performed, a price, a user rating, an availability of a communication service, a satisfaction level of the user, congestion, throughput, latency, and a user defined parameter.

The query engine 120 can be configured to extract the plurality of parameters from the natural language query based on techniques like NLP (Natural Language Processing) technique etc. Further, the query engine 120 can be configured to generate the structural query based on the at least one parameter from the plurality of parameters. After generating the structural query, the query engine 120 can be configured to send the structural query to the information source 300. Further, the query engine 120 can be configured to receive the plurality of results as response to the structural query from the information source 300. Further, the query engine 120 can be configured to select the candidate result from the plurality of results based on the degree of relevance. In an embodiment, the candidate result is at least one of a contact item, a service, an application, a message identifier, a web site address, a phone number, an e-mail identifier, a geographical address, a geographical location, and a SNS identifier. In an example, various services that a telecom company may provide is check bill, browse offers, recharge, talk to executive, or the like. In this case, the natural language query can be “Connect service Talk to executive”. This query would return direct access point to the required service. In an embodiment, the degree of relevance is dynamically defined based on at least one of the plurality of parameters, a current location of the electronic device 100, and context information. Further, the query engine 120 can be configured to perform the action corresponding to the candidate result as the response to the natural language query.

In an embodiment, performing the action includes opening an application, filling data in an application, terminating an application, composing a message, sending a message, displaying the candidate result, initiating a communication service, terminating a communication service, or updating a service. In an embodiment, the action includes a series of actions performed as a response to the natural language query. The series of actions is determined based on the plurality of parameters.

In another embodiment, the query engine 120 can be configured to receive the natural language query including the plurality of parameters. After generating the structural query, the query engine 120 can be configured to receive at least one result corresponding to the structural query from the information source 300.

Further, the query engine 120 can be configured to adjust the structural query by adjusting the at least one parameter from the plurality of parameters if the at least one result corresponding to the structural query is not received from the information source 300. Further, the query engine 120 can be configured to retrieve a result corresponding to the adjusted structural query from the information source 300. Further, the query engine 120 can be configured to perform the action corresponding to the result as the response to the structural query.

The memory unit 130 may include one or more computer-readable storage media. The memory unit 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory unit 130 may, in some examples, be considered a non-transitory storage medium. The term “non-transitory” may indicate that the storage medium is not embodied in a carrier wave or a propagated signal. However, the term “non-transitory” should not be interpreted that the memory unit 130 is non-movable. In some examples, the memory unit 130 can be configured to store larger amounts of information than the memory. In certain examples, a non-transitory storage medium may store data that can, over time, change (e.g., in Random Access Memory (RAM) or cache). The communication unit 140 communicates internally with the units and externally with networks.

Unlike conventional systems and methods, the proposed method can be used to perform the actions such as initiating and establishing the call, sending the email, sending the message, saving the contact information, automatic form filling, placing the order, etc. Further, the proposed method can be used to perform the operations (i.e., actions) with location parameters such as the location of the electronic device 100 or any other specific location (not necessarily the location of the electronic device 100) and further additional parameters such as the availability, the user rating, the price, etc. Further, the proposed method allows for adjusting the at least one parameter from the plurality of parameters for the structural query (i.e., automatic zoning to expand or shrink the zone). The uses of the following proposed invention are described in detail below:

1. The proposed method can be used by the user to perform the actions such as calling, messaging, saving, ordering, etc. even in the absence of essential information such as the contact number, web site address, etc.

2. The proposed method can be used for quick and handy execution of the action in case of the emergency situations for required services.

3. The proposed method can be used for searching various kinds of services such as restaurant, electrician, taxi, drugs, etc.

Unlike conventional systems and methods, the following advantages are achieved, by using the proposed method, as described below:

1. Ease of user is increased due to automatically performing the action by retrieving the single candidate result from the information source 300.

2. Saves user effort in gathering essential information as well as in performing the actions

3. Augmentating of information renders user with required information based on the parameters such as location of service provider, etc.

The FIG. 2 shows the electronic device 100 but it is to be understood that other embodiments are not limited thereon. In other embodiments, the electronic device 100 may include less or more number of units. In an embodiment, the electronic device 100 can include at least one of the units, and not included units can be omitted. Further, the labels or names of the units are used only for illustrative purpose and does not limit the scope of the invention. One or more units can be combined together to perform same or substantially similar function in the electronic device 100.

FIG. 3 illustrates various units of a query engine, according to an embodiment as disclosed herein. In an embodiment, the query engine includes at least one of a query analyzer 112, a query generator 114, a query adjustor 116, and an action executor unit 118. In an embodiment, one of an electronic device and a server can includes the query engine. In an embodiment, both of an electronic device and a server each can include the query engine. In an embodiment, the query analyzer 112 can be configured to receive the natural language query including the plurality of parameters. Further, the query analyzer 112 can be configured to analyze the natural language query to extract the plurality of parameters based on techniques such as the NLP technique. Further, the query generator 114 can be configured to generate the structural query based on the at least one parameter from the plurality of parameters. After generating, the query generator 114 can be configured to send the structural query to the information source 300. Further, the query generator 114 can be configured to receive a plurality of results as the response to the structural query from the information source 300 by the query generator 114. Further, the query generator 114 can be configured to select the candidate result from the plurality of results based on the degree of relevance. The query executor unit 118 can be configured to perform the action corresponding to the candidate result as a response to the natural language query.

In another embodiment, After generating the structural query, the query generator 114 can be configured to send the structural query to the information source 300 and receive at least one result corresponding to the structural query from the information source 300. The query adjustor 116 can be configured to adjust the at least one parameter from the plurality of parameters if the at least one result corresponding to the structural query is not received from the information source 300. The query generator 114 can be configured to adjust the structural query based on the adjustment. Further, the query generator 114 can be configured to retrieve a result corresponding to the adjusted structural query from the information source 300. The action executor unit 118 can be configured to perform the action corresponding to the result as a response to the adjusted structural query.

The FIG. 3 shows the query engine but it is to be understood that other embodiments are not limited thereon. In other embodiments, the query engine may include less or more number of units. In an embodiment, the query engine can include at least one of the units, and not included units can be omitted. Further, the labels or names of the units are used only for illustrative purpose and does not limit the scope of the invention. One or more units can be combined together to perform same or substantially similar function in the query engine.

FIG. 4 illustrates various units of a server, according to an embodiment as disclosed herein. In an embodiment, the server 200 includes at least one of a controller unit 210, a query engine 220, a memory unit 230, and a communication unit 240. In an embodiment, the information source(s) 300 can be omitted and can be within an electronic device. In an embodiment, the controller unit 210 can perform the functionalities of the query engine 220 as described below without departing from the scope of the invention. In an embodiment, the query engine 220 can be configured to receive the structural query including the plurality of parameters from the electronic device 100. Further, the query engine 220 can be configured to retrieve the plurality of results corresponding to the structural query from the information source 300. Further, the query engine 220 can be configured to select the candidate result from the plurality of results based on the degree of relevance. Further, the query engine 220 can be configured to send the candidate result to the electronic device 100 to perform the action corresponding to the candidate result.

In another embodiment, the query engine 220 can be configured to receive the structural query including the plurality of parameters. Further, the query engine 220 can be configured to receive at least one result corresponding to the structural query is received from the information source 300. Further, the query engine 220 can be configured to generate a modified structural query by adjusting at least one parameter from the plurality of parameters if the at least one result corresponding to the structural query is not received from the information source 300. Further, the query engine 220 can be configured to retrieve a result corresponding to the modified structural query from the information source 300. Further, the query engine 220 can be configured to send the result to the electronic device to perform an action corresponding to the result.

The memory unit 230 may include one or more computer-readable storage media. The memory unit 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory unit 230 may, in some examples, be considered a non-transitory storage medium. The term “non-transitory” may indicate that the storage medium is not embodied in a carrier wave or a propagated signal. However, the term “non-transitory” should not be interpreted that the memory unit 230 is non-movable. In some examples, the memory unit 230 can be configured to store larger amounts of information than the memory. In certain examples, a non-transitory storage medium may store data that can, over time, change (e.g., in Random Access Memory (RAM) or cache). The communication unit 240 communicates internally with the units and externally with networks.

The FIG. 4 shows the server 200 but it is to be understood that other embodiments are not limited thereon. In other embodiments, the server 200 may include less or more number of units. In an embodiment, the server 200 can include at least one of the units, and not included units can be omitted. Further, the labels or names of the units are used only for illustrative purpose and does not limit the scope of the invention. One or more units can be combined together to perform same or substantially similar function in the server 200.

FIG. 5a is an example sequence diagram related to a method for selecting a relevant contact information by a server, according to an embodiment as disclosed herein. In an embodiment, the sequence diagram illustrates a sequence of steps between the electronic device 100 and the server 200.

At step 502a, the server 200 receives the structural query generated based on the natural language query including the plurality of parameters from the electronic device 100.

At step 504a, after receiving the structural query, the server 200 selects a relevant candidate result (i.e., a relevant contact (a relevant service provider)) based on the degree of relevance. In an embodiment, the degree of relevance is dynamically defined based on at least one of the plurality of parameters, the current location of the electronic device 100, and the context information.

At step 506a, the server 200 can select a relevant information type after selecting the relevant candidate result. The relevant information type is selected based on a type of action to be performed. For example, if the type of action to be performed is “Order”, contact information related to website field is selected as the relevant information type among a plurality of contacts of the selected relevant candidate result.

At step 508a, if needed, the server 200 can perform adjusting at least one parameter from the plurality of parameters (i.e., automatic zoning to expand or shrink the zone) of the structural query. In an embodiment, if there are a plurality of outputs in the step 506a, the adjustment can be needed. In an embodiment, if there is no output in the step 506a, the adjustment can be needed. In an embodiment, if there are a plurality of outputs in the step 504a, the adjustment can be needed. In an embodiment, if there is no output in the step 504a, the adjustment can be needed.

At step 510a, the server 200 sends a selected relevant contact information to the electronic device 100 to perform the action corresponding to the selected relevant contact information.

FIG. 5b is an example sequence diagram related to a method for selecting a relevant contact information by an electronic device, according to an embodiment as disclosed herein. In an embodiment, the sequence diagram illustrates a sequence of steps between the electronic device 100 and the server 200 as described below:

At step 502b, the electronic device 100 sends the structural query which is generated based on the natural language query including the plurality of parameters to the server 200. At step 504b, receiving continuous stream of contacts (i.e., plurality of results) from the server 200.

At step 506b, after receiving the stream of contacts, the electronic device 100 selects a relevant candidate result (i.e., a relevant contact (a relevant service provider)) based on the degree of relevance.

At step 508b, the electronic device 100 can select a relevant information type after selecting the relevant candidate result. The relevant information type is based on a type of action to be performed. For example, if the type of action to be performed is “Call”, phone number is selected as the relevant information type among a plurality of contacts of the selected relevant candidate result.

At step 510b, if needed, the electronic device 100 performs adjusting the at least one parameter from the plurality of parameters (i.e., automatic zoning to expand or shrink the zone) of the structural query. In an embodiment, if there are a plurality of outputs in the step 506b, the adjustment can be needed. In an embodiment, if there is no output in the step 506b, the adjustment can be needed. In an embodiment, if there are a plurality of outputs in the step 508b, the adjustment can be needed. In an embodiment, if there is no output in the step 508b, the adjustment can be needed.

At step 512b, the electronic device 100 sends acknowledgment message to the server 200.

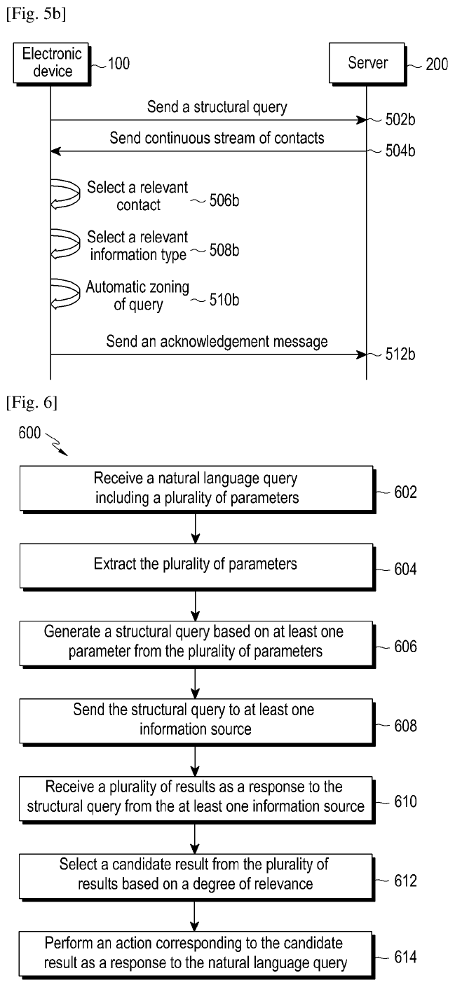

FIG. 6 is a flow chart 600 illustrating an operation method for an electronic device, according to an embodiment as disclosed herein.

At step 602, the method includes receiving the natural language query including the plurality of parameters. The method allows the query engine 120 to receive the natural language query including the plurality of parameters.

At step 604, the method includes extracting the plurality of parameters based on techniques such as the NLP technique. The method allows the query engine 120 to extract the plurality of parameters based on the NLP technique.

At step 606, the method includes generating the structural query based on the at least one parameter from the plurality of parameters. The method allows the query engine 120 to generate the structural query based on the at least one parameter from the plurality of parameters.

At step 608, the method includes sending the structural query to the information source 300. The method allows the query engine 120 to send the structural query to the information source 300.

At step 610, the method includes receiving a plurality of results as a response to the structural query from the information source 300. The method allows the query engine 120 to receive the plurality of results as a response to the structural query from the information source 300.

At step 612, the method includes selecting a candidate result from the plurality of results based on the degree of relevance. The method allows the query engine 120 to select the candidate result from the plurality of results based on the degree of relevance.

At step 614, the method includes performing an action corresponding to the candidate result as a response to the natural language query. The method allows the query engine 120 to perform the action corresponding to the candidate result as a response to the natural language query.

Unlike conventional systems and methods, the proposed method can be used to provide a storage effective contact database to the user. Further, the proposed method can be used to optimize bandwidth utilization for data transfer and extracts only the contact information (i.e., candidate result) which is relevant for the action to be executed (or performed). All the existing solutions consider the service providing contacts which are nearest to the electronic device 100. However, the proposed method allows the user to perform the actions with respect to other service providers at other desired locations too. The conventional systems and methods are helpful only when the user of the electronic device 100 is unaware of the geographic location of the nearest facility of the service provider but does know specific information i.e., a number to call. Further, none of the conventional systems and methods considers the parameters such as the availability, the user rating, the price, etc. while deciding the service contact. Unlike conventional systems and methods, the proposed method can be used even when the user is unaware of any contact information and specifies just the service type. In addition to calling, the proposed method allows the user to perform the actions such as sending the e-mail, sending the message, saving the contact information, automatic form filling, placing the order, etc.

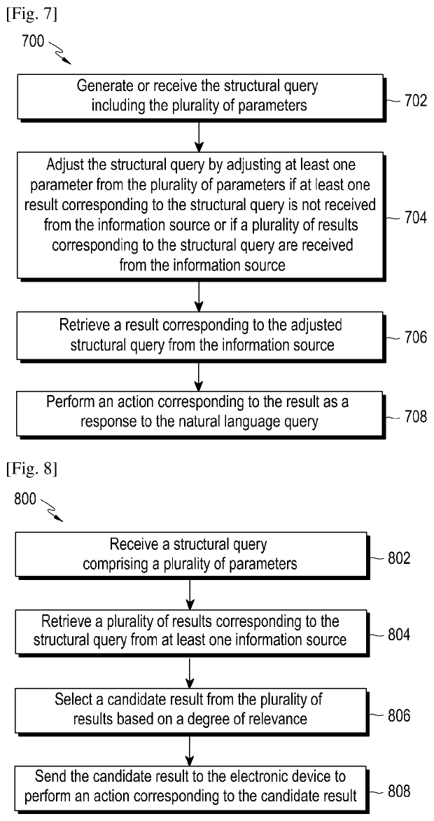

FIG. 7 illustrates a flow chart 700 for operations of an electronic device, according to an embodiment as disclosed herein. The description of features overlapping with the embodiment described above can be omitted.

At step 702, the operations start after generating or receiving the structural query including the plurality of parameters. The operations allow the query engine 120 to generate or receive the structural query including the plurality of parameters.

At step 704, the operations include adjusting the structural query by adjusting at least one parameter from the plurality of parameters if at least one result corresponding to the structural query is not received from the information source 300. The operations allow the query engine 120 to adjust the structural query by adjusting the at least one parameter from the plurality of parameters if at least one result corresponding to the structural query is not received from the information source 300 or if a plurality of results corresponding to the structural query are received from the information source 300.

At step 706, the operations include retrieving a result corresponding to the adjusted structural query from the information source 300. The operations allow the query engine 120 to retrieve the result corresponding to the adjusted structural query from the information source 300.

At step 708, the operations include performing an action corresponding to the result as a response to the natural language query. The operations allow the query engine 120 to perform the action corresponding to the result as a response to the natural language query.

FIG. 8 is a flow chart 800 illustrating operations for a server, according to an embodiment as disclosed herein.

At step 802, the operations include receiving the structural query including the plurality of parameters. The operations allow the query engine 220 to receive the structural query including the plurality of parameters.

At step 804, the operations include retrieving a plurality of results corresponding to the structural query from the information source 300. The operations allow the query engine 220 to retrieve the plurality of results corresponding to the structural query from the information source 300.

At step 806, the operations include selecting a candidate result from the plurality of results based on the degree of relevance. The operations allow the query engine 220 to select the candidate result from the plurality of results based on the degree of relevance.

At step 808, the operations include sending the candidate result to the electronic device 100 to perform an action corresponding to the candidate result. The operations allow the query engine 220 to send the candidate result to the electronic device 100 to perform the action corresponding to the candidate result.

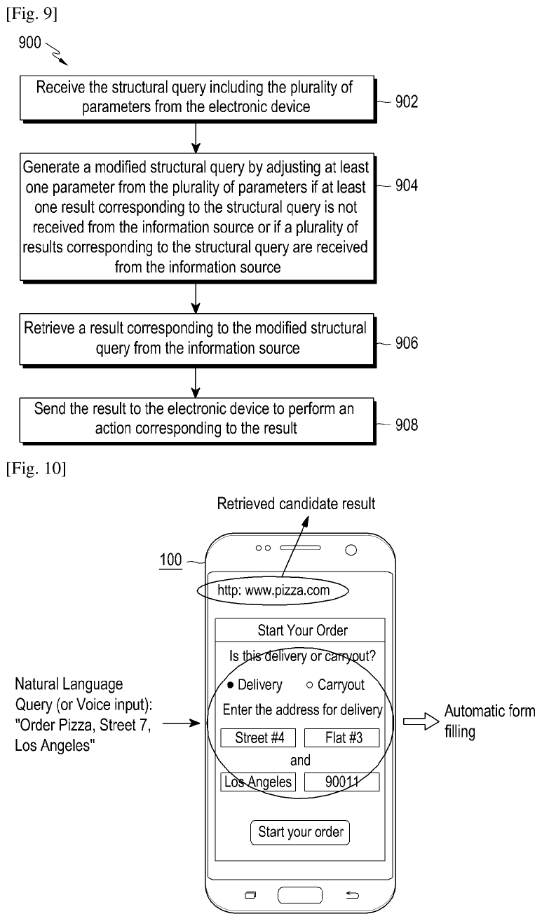

FIG. 9 is a flow chart 900 illustrating operations for a server, according to an embodiment as disclosed herein. The description of features overlapping with the embodiment described above can be omitted.

At step 902, the operations include receiving the structural query including the plurality of parameters from the electronic device 100. The operations allow the query engine 220 to receive the structural query including the plurality of parameters from the electronic device 100.

At step 904, the operations include generating a modified structural query by adjusting at least one parameter from the plurality of parameters if at least one result corresponding to the structural query is not received from the information source 300 or if a plurality of results corresponding to the structural query are received from the information source 300. The operations allow the query engine 220 to generate a modified structural query by adjusting the at least one parameter from the plurality of parameters if the at least one result corresponding to the structural query is not received from the information source 300 or if the plurality of results corresponding to the structural query are received from the information source 300.

At step 906, the operations include retrieving a result corresponding to the modified structural query from the information source 300. The operations allow the query engine 220 to retrieve the result corresponding to the modified structural query from the information source 300.

At step 908, the operations include sending the result to the electronic device 100 to perform an action corresponding to the result. The operations allow the query engine 220 to send the result to the electronic device 100 to perform the action corresponding to the result.

The various actions, acts, blocks, steps, or the like in the flow chart shown from FIGS. 6-9 may be performed in the order presented, in a different order or simultaneously. Further, in some embodiments, some of the actions, blocks, steps, or the like may be omitted, added, modified, skipped, or the like without departing from the scope of the invention.

FIG. 10 illustrates an example scenario for an electronic device performing an action as a response to a natural language query, according to an embodiment as disclosed herein. Consider a scenario in which the action “Order” need to be performed related to the service “Pizza” with additional location parameter “Street 7, Los Angeles”. The process is initiated when the user provides the natural language query “Order Pizza, Street 7, Los Angeles” as the voice input (or voice command or text command) to the electronic device 100. In an example, an audio API (Application Programming Interface) records the voice input and triggers the process to perform the “Order” action. The user provides the following voice input with a pause in between the parameters i.e.,

“Order <pause> Pizza <pause> Street 7 Los Angeles”

Further, the entire process can be divided into following steps as described below:

1. Command Extraction from voice input:

The query engine 120 considers the pause (i.e., time lag between the consecutive words) in the voice input as delimiters and splits the voice input into various parameters such as:

Parameter-1: Order, Parameter-2: Pizza, Parameter-3: Street 7, Los Angeles

2. Processing of extracted command parameters:

In this step, the query engine 120 recognizes and identifies the parameters and tags them for further structural query generation. In an example, the parameters are tagged as Operation Type (i.e., subject): Parameter-1: Order, Service Type (i.e., object): Parameter-2: Pizza, and Filter-1: Parameter-3: Street 7, Los Angeles

Here, the query engine 120 expects the voice input to be in following format as <Operation type><pause><Service type><pause><Filter 1><pause><Filter 2> . . . so on

3. Query Generation:

In this step, using the extracted information from the voice input, the query engine 120 generates the structural query to extract the contact information (i.e., candidate result) from the information source 300 available within the electronic device 100 or at the remote location within the server 200. The query engine 120 utilizes the values of the attributes other than the operation type for the structural query. Based on the generated query, the plurality of results is retrieved from the information source 300. As an embodiment for implementation, Google Places API (Application Programming Interface) can be used to extract the plurality of results (information) based on the service type and various filter parameters. The API provides following options as described below:

i. Nearby search: return a list of nearby places based on a user's location

ii. Text search: returns a list of nearby places based on a search string. For example: “Pizza”.

iii. Radar search: returns a large list of places within a specified search results, but with less detail than either Nearby search or Text search

iv. Place details requests: return more detailed information about a specific place, including user reviews.

Thus, the structural query in the required format for Google Places API is generated which is of following format.

https://maps.apis.com/maps/api/place/textsearch/xml?query=Pizza+ Hut+Stree+7+Los+Angeles&key=<key>

Further, the query engine 120 retrieves the plurality of results (i.e., array of PlaceResult objects) which has various information related to the requested service at the requested location. One such parameter that is returned in the object is place_id which is a textual identifier that uniquely identifies a place. Using the place_id, the contact information including the phone number, website address, opening time etc. are extracted through a query.

Such a query returns data in a JSON (Java Script Object Notation) format from which following information can be retrieved i.e.,

“Formatted address”: “718 S Los Angeles St, Los Angeles, Calif. 90014, United States”, “Formatted_phone_number”: “+1 213-489-3863”, “Website”: “order.pizza.com”

Alternatively, the contact information can be retrieved from the information source 300 at the remote location in the server 200. The contact information for “Pizza Street 7 Los Angeles” can be retrieved using the information source 300 in the server 200. Further, based on the operation type, the required contact information (i.e., candidate result) is extracted from the data returned in response to the structural query. As the operation type is “Order”, the contact information related to website field (i.e., web site address) is extracted to perform the action i.e., filling the form to order the pizza. In this scenario, the action to be performed is “Order”, thus the query engine 120 performs the sub-operations as “using the website address information as extracted, the website page is opened”, and “the information related to the user is automatically filled in the form as shown in the FIG. 10”.

Further, the user can fill the order details himself/herself. Unlike conventional systems and methods, the user does not search the contact information for the required service. Further, the user does not manually open the website address and does not require for filling the details in the order form manually.

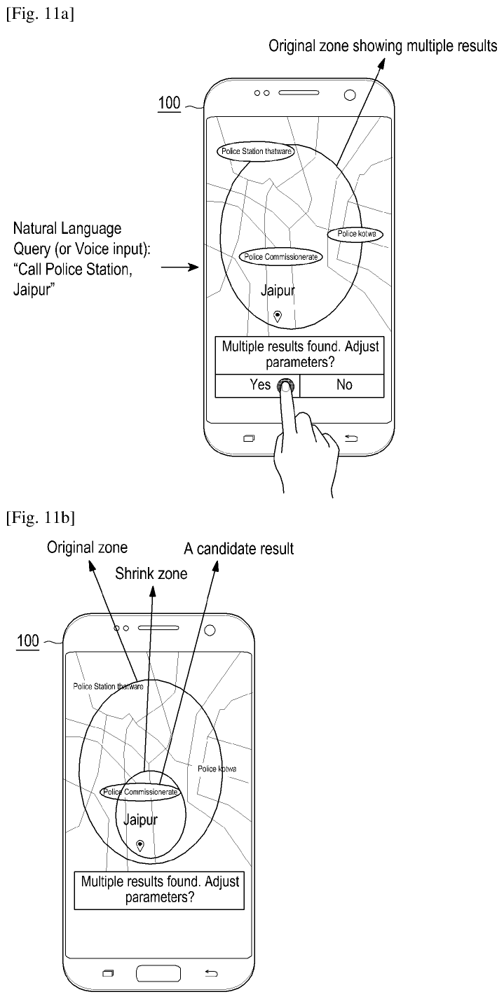

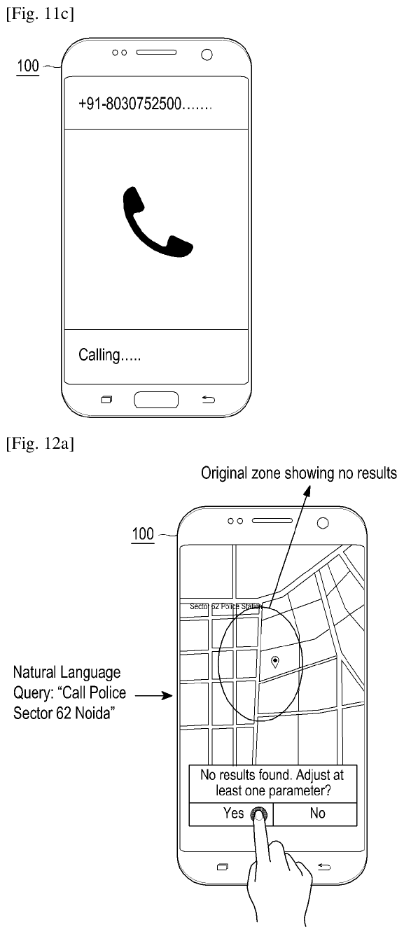

FIGS. 11a-11c illustrate an example scenario for a process of an electronic device to perform an action as a response to a natural language query, according to an embodiment as disclosed herein. Consider a scenario in which the action “Call” need to be performed related to the service “Police Station” with additional location parameter (i.e., filter) “Jaipur”. As explained above in the FIG. 10, the process is initiated when the user provides the natural language query “Call Police Station, Jaipur” as the voice input to the electronic device 100 as shown in the FIG. 11a. The user provides following voice input with the pause in between the parameters i.e.,

“Call <pause> Police Station <pause> Jaipur”

After receiving the natural language query, the query engine 120 in the electronic device 100 extracts the plurality of parameters based on the NLP technique and splits the natural language query into various parameters such as Parameter-1: Call, Parameter-2: Police Station, Parameter-3: Jaipur

Further, the query engine 120 tags the parameters for further query generation. The parameters are tagged as Operation Type: Parameter-1: Call, Service Type: Parameter-2: Police Station, and Filter: Parameter-3: Jaipur By using the extracted parameters (i.e., at least one parameter) from the natural language query, the query engine 120 generates the structural query to retrieve the plurality of results from the information source 300 available within the electronic device 100 or at the remote location within the server 200. The generated structural query is sent to the information source 300 by the query engine 120. In response to sending of the structural query, the query engine 120 receives the plurality of results (i.e., results within an original zone) which are displayed on a screen of the electronic device 100 as shown in the FIG. 11a. In an embodiment, after displaying the plurality of results, the user is provided with an option to select whether to adjust the at least one parameter from the plurality of parameters (i.e., zone shrinking)

In another embodiment, without providing the option to the user to select, the at least one parameter can be adjusted automatically to reduce the number of results and to select only one candidate result which is more appropriate to the structural query and based on the degree of relevance as shown in the FIG. 11b (for example: near to the location of the electronic device 100). After selecting the candidate result, the candidate result related to the phone number field is extracted and call is automatically initiated and established with the police station using the phone application as shown in the FIG. 11c.

Similarly, the proposed method can be used in case of emergency situations when the user does not have access to the contact information such as phone number, e-mail address, etc. Such emergency services may include Police service; Ambulance service, Fire Brigade service etc. Consider a scenario in which the user requires “Apollo ambulance services” in an unfamiliar location. In such a situation following is course of action that is followed:

1. The user specifies the operation type and service type by providing the natural language query. The example operation is “Call” and service type is “Apollo Ambulance” and the filter is “Delhi”.

2. Through existing speech recognition methods, the operation and service type is extracted along with the filter parameter (i.e., location parameter).

3. The query engine 120 generates the structural query using the service type and the filter. In an example implementation, by using the existing methods, following queries described below are sent to publicly available information sources (i.e., information source 300).

query=Apollo+Ambulance+Delhi&key=<key>

place/details/json?placeid=Jk831t_tDeuEmsRUsoyG856gtYu4&key

4. The contact information related to the phone number in the returned JSON format data is extracted and call is automatically initiated and established to that phone number.

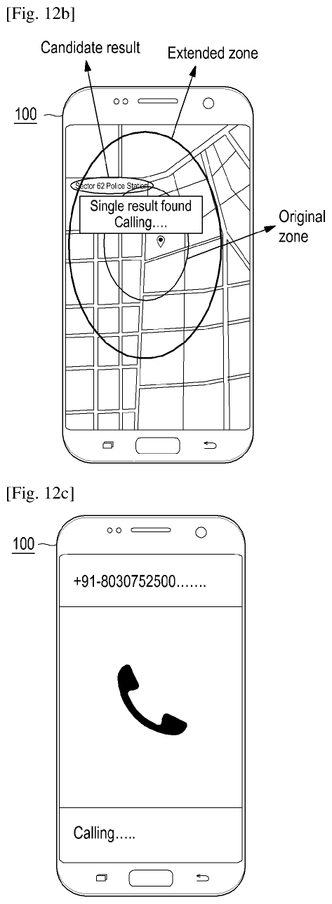

FIGS. 12a-12c illustrate an example scenario for a process of an electronic device to perform an action as a response to a natural language query, according to an embodiment as disclosed herein. Consider a scenario in which the action “Call” need to be performed related to the service “Police Station” with additional location parameter “Sector 62 Noida”. The process is initiated when the user provides the natural language query “Call Police Station, Sector 62 Noida” as the voice input to the electronic device 100 as shown in the FIG. 12a. The user provides following voice input with the pause in between the parameters i.e.,

“Call <pause> Police Station <pause> Sector 62 Noida”

After receiving the natural language query, the query engine 120 in the electronic device 100 extracts the plurality of parameters based on techniques such as the NLP technique and splits the natural language query into various parameters such as Parameter-1: Call, Parameter-2: Police Station, and Parameter-3: Sector 62 Noida

Further, the query engine 120 tags the parameters for further query generation. The parameters are tagged as Operation Type: Parameter-1: Call, Service Type: Parameter-2: Police Station, and Filter: Parameter-3: Sector 62 Noida. By using the extracted parameters (i.e., at least one parameter) from the natural language query, the query engine 120 generates the structural query to retrieve the plurality of results from the information source 300 available within the electronic device 100 or at the remote location within the server 200. The generated structural query is sent to the information source 300 by the query engine 120. After sending the structural query, the query engine 120 determines that no results are retrieved from the information source corresponding to the structural query. The at least one parameter from the plurality of parameters are adjusted to modify the structural query (i.e., zone extending). The user is provided with an option to select whether to adjust the at least one parameter from the plurality of parameters. By using the modified structural query, the query engine 120 retrieves the single candidate result corresponding to the modified structural query from the information source 300 as shown in the FIG. 12b. Further, based on the operation type, the required contact information (i.e., candidate result) is extracted from the candidate result returned in response to the modified structural query. As the operation type is “Call”, the contact information related to the phone number is extracted to perform the action i.e., calling the police station. In this scenario, the action to be performed is “Call”, thus the query engine 120 automatically initiates and establishes the call with the police station as shown in the FIG. 12c.

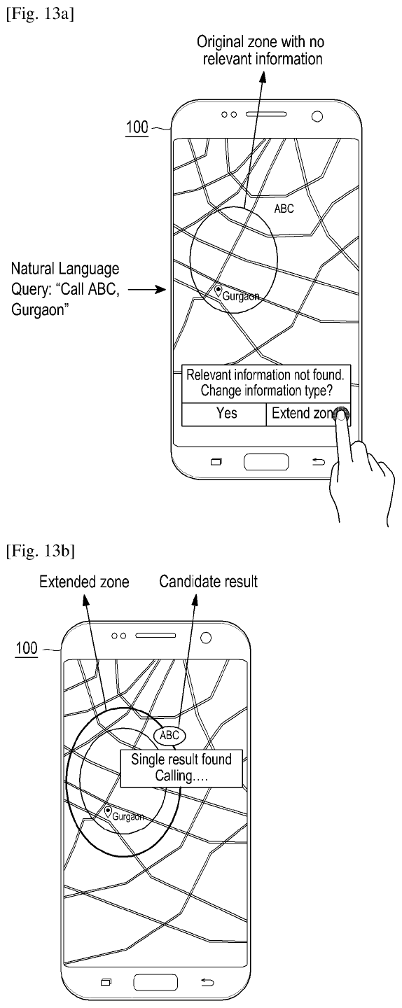

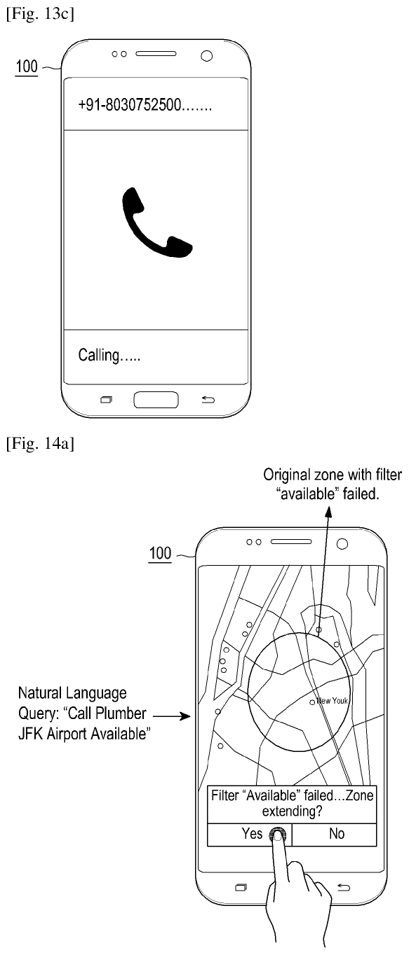

FIGS. 13a-13c illustrate an example scenario for a process of an electronic device to perform an action as a response to a natural language query, according to an embodiment as disclosed herein. Consider a scenario in which the action “Call” need to be performed related to the service “ABC” with additional location parameter “Gurgaon”. The process is initiated when the user provides the natural language query “Call ABC, Gurgaon” as the voice input to the electronic device 100 as shown in the FIG. 13a. The user provides following voice input with the pause in between the parameters i.e.,

“Call <pause> ABC <pause> Gurgaon”

After receiving the natural language query, the query engine 120 in the electronic device 100 extracts the plurality of parameters based on techniques such as the NLP technique and splits the natural language query into various parameters such as Parameter-1: Call, Parameter-2: ABC, and Parameter-3: Gurgaon

Further, the query engine 120 tags the parameters for further query generation. The parameters are tagged as Operation Type: Parameter-1: Call, Service Type: Parameter-2: ABC, and Filter: Parameter-3: Gurgaon

By using the extracted parameters (i.e., at least one parameter) from the natural language query, the query engine 120 generates the structural query to retrieve the plurality of results from the information source 300 available within the electronic device 100 or at the remote location within the server 200. The generated structural query is sent to the information source 300 by the query engine 120. After sending the structural query, the query engine 120 determines that relevant information is not found in the information source 300. Further, the user is provided with an option whether to change information type or to extend the zone (i.e., adjust the at least one parameter from the plurality of parameters) as shown in the FIG. 13a. As the user performs the gesture (selection) to extend zone area (i.e., broaden), the structural query is modified to retrieve the relevant information type as shown in the FIG. 13a. By using the modified structural query, the query engine 120 retrieves the single result (i.e., relevant information type) corresponding to the modified structural query from the information source 300 as shown in the FIG. 13b. Further, based on the operation type, the required contact information (i.e., candidate result) is extracted from the result returned in response to the modified structural query. As the operation type is “Call”, the contact information related to the phone number is extracted to perform the action i.e., calling ABC. In this scenario, the action to be performed is “Call”, thus the query engine 120 automatically initiates and establishes the call to the ABC as shown in the FIG. 13c.

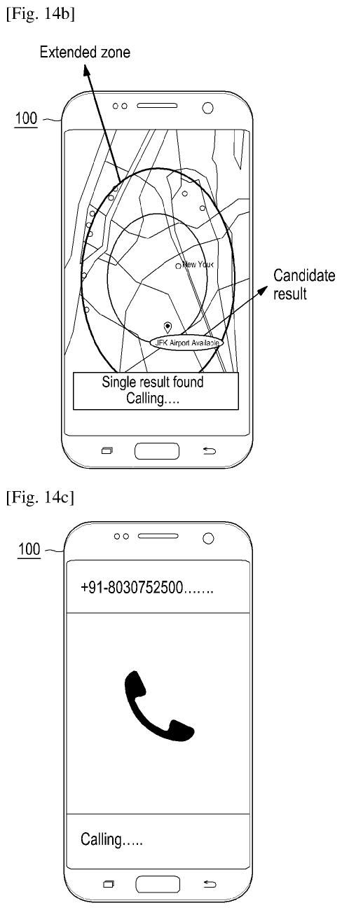

FIGS. 14a-14c illustrate an example scenario for a process of an electronic device to perform an action as a response to a natural language query, according to an embodiment as disclosed herein. The process is initiated when the user provides the natural language query “Call Plumber, JFK Airport, Available” as the voice input to the electronic device 100 as shown in the FIG. 14a. The user provides following voice input with the pause in between the parameters i.e.,

“Call <pause> Plumber <pause> JFK Airport <pause> Available”

After receiving the natural language query, the query engine 120 in the electronic device 100 extracts the plurality of parameters based on techniques such as the NLP technique and splits the natural language query into various parameters such as Parameter-1: Call, Parameter-2: Plumber, Parameter-3: JFK Airport, and Parameter-4: Available

Further, the query engine 120 tags the parameters for further query generation. The parameters are tagged as Operation Type: Parameter-1: Call, Service Type: Parameter-2: Plumber, First Filter: Parameter-3: JFK Airport, and Second Filter: Parameter-4: Available

By using the extracted parameters (i.e., at least one parameter) from the natural language query, the query engine 120 generates the structural query to retrieve at least one results from the information source 300 available within the electronic device 100 or at the remote location within the server 200. The generated structural query is sent to the information source 300 by the query engine 120. In response to sending of the structural query, the query engine 120 determines two services (i.e., results) in the zone “JFK Airport”. However, none of these results are available and the filer “Available” is failed. Thus, in an embodiment, the query engine 120 automatically extends the zone (i.e., adjusts the at least one parameter from the plurality of parameters) and searches for the results satisfying the filter parameters. In another embodiment, the user performs the gesture (selection) on the provided option whether to extend the zone (i.e., adjust the at least one parameter) as shown in the FIG. 14a.

In the extended zone, the query engine 120 retrieves a single result satisfying the filter parameter “Available” corresponding to the modified structural query from the information source 300 as shown in the FIG. 14b. Further, based on the operation type, the required contact information (candidate result) is extracted from the result returned in response to the modified structural query. As the operation type is “Call”, the contact information related to phone number is extracted to perform the action i.e., calling the Plumber. In this scenario, the action to be performed is “Call”, thus the query engine 120 automatically initiates and establishes the call to/with the Plumber as shown in the FIG. 14c.

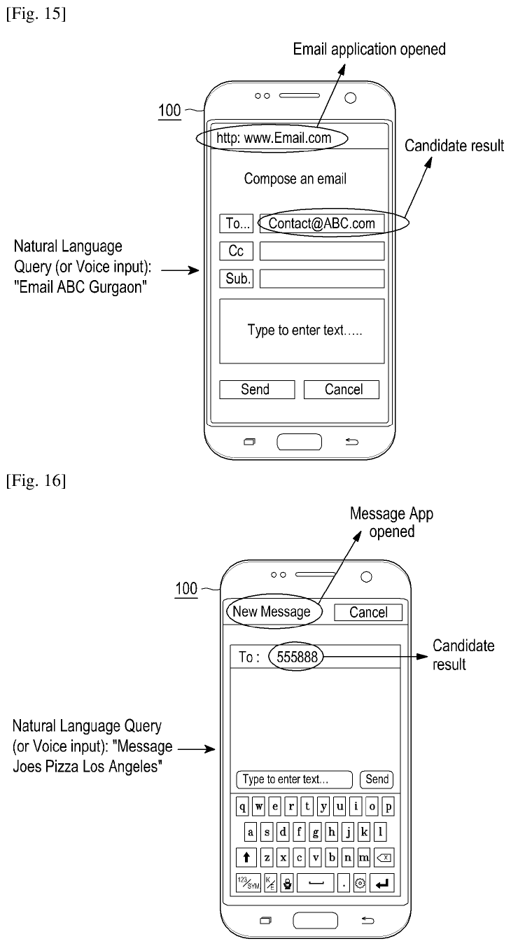

FIG. 15 illustrates an example scenario for an electronic device performing an action as a response to a natural language query, according to an embodiment as disclosed herein. Consider a scenario in which the action “Email” need to be performed related to the service “ABC” with the additional location parameter “Gurgaon”.

Further, the process is initiated when the user provides the natural language query “Email ABC, Gurgaon” as the voice input to the electronic device 100 as shown in the FIG. 15. The user provides following voice input with the pause in between the parameters i.e.,

“Email <pause> ABC <pause> Gurgaon”

After receiving the natural language query, the query engine 120 in the electronic device 100 extracts the plurality of parameters based on techniques such as the NLP technique and splits the natural language query into various parameters such as Parameter-1: Email, Parameter-2: ABC and Parameter-3: Gurgaon

Further, the query engine 120 tags the parameters for further query generation. The parameters are tagged as Operation Type: Parameter-1: Email, Service Type: Parameter-2: ABC, and Filter: Parameter-3: Gurgaon

By using the extracted parameters (i.e., at least one parameter) from the natural language query, the query engine 120 generates the structural query to retrieve the plurality of results from the information source 300 available within the electronic device 100 or at the remote location within the server 200. The generated structural query is sent to the information source 300 by the query engine 120. In response to sending of the structural query, the query engine 120 receives the plurality of results. The query engine 120 selects a candidate result (i.e., contact information) from the plurality of results based on the degree of relevance. After selecting the candidate result, the candidate result related to the email identifier field is extracted and the window that composes email is opened with the extracted email identifier as shown in the FIG. 15.

FIG. 16 illustrates an example scenario for an electronic device performing an action as a response to a natural language query, according to an embodiment as disclosed herein. Consider a scenario in which the action “sending the message” need to be performed related to the service “Joes Pizza” with the additional location parameter “Los Angeles”. The process is initiated when the user provides the natural language query “Message, Joes Pizza, Los Angeles” as the voice input to the electronic device 100 as shown in the FIG. 16. The user provides following voice input with the pause in between the parameters i.e.,

“Message <pause> JoesPizza <pause> Los Angeles”

After receiving the natural language query, the query engine 120 in the electronic device 100 extracts the plurality of parameters based on the NLP technique and splits the natural language query into various parameters such as Parameter-1: Message, Parameter-2: JoesPizza, and Parameter-3: Los Angeles. Further, the query engine 120 tags the parameters for further query generation. The parameters are tagged as Operation Type: Parameter-1: Message, Service Type: Parameter-2: JoesPizza, and Filter: Parameter-3: Los Angeles. By using the extracted parameters (i.e., at least one parameter) from the natural language query, the query engine 120 generates the structural query to retrieve the plurality of results from the information source 300 available within the electronic device 100 or at the remote location within the server 200. The generated structural query is sent to the information source 300 by the query engine 120. In response to sending of the structural query, the query engine 120 receives the plurality of results. The query engine 120 selects a candidate result (i.e., contact information) from the plurality of results based on the degree of relevance. After selecting the candidate result, the candidate result related to the message identifier field is extracted and the window that composes message is opened with the extracted message identifier as shown in the FIG. 16.

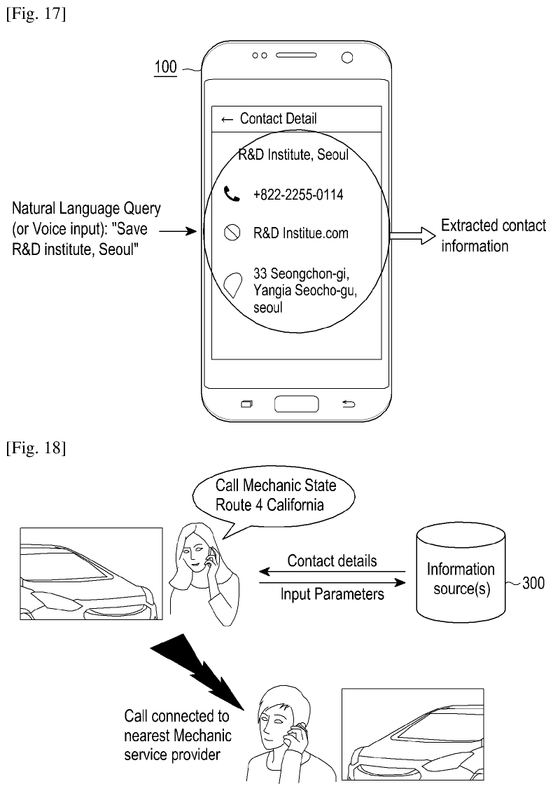

FIG. 17 illustrates an example scenario for an electronic device performing an action as a response to a natural language query, according to an embodiment as disclosed herein. Similarly using the process described above, the contact details (i.e., contact information) related to the phone number field, email identifier field, address field, and other information are extracted. As shown in the FIG. 17, a adding-contact window is opened with the contact details, the extracted phone number, email identifier, address, and other information, which are automatically filled in add-contact form using contact application. Further, the contact details are stored using the service type and filters in the electronic device 100.

FIG. 18 illustrates an example scenario where the proposed method allows user to get connected to at least one service provider when stuck in an emergency situation. In the example, the call is automatically initiated and established to a nearest mechanic service provider after receiving the natural language query: “Call Mechanic State Route 4, California” by the query engine 120, according to an embodiment as disclosed herein. Consider a scenario in which the action “establishing the call with mechanic” need to be performed related to the service “Mechanic service” with additional location parameter “State Route 4, California”. Further, the process is initiated when the user provides the natural language query “Call Mechanic State Route 4, California” as the voice input to the electronic device 100 as shown in the FIG. 18. The user provides following voice input with the pause in between the parameters i.e.,

“Call <pause> Mechanic <pause> State Route 4, California”

After receiving the natural language query, the query engine 120 in the electronic device 100 extracts the plurality of parameters based on techniques such as NLP technique and splits the natural language query into various parameters such as Parameter-1: Call, Parameter-2: Mechanic, and Parameter-3: State Route 4, California. Further, the query engine 120 tags the parameters for further query generation. The parameters are tagged as Operation Type: Parameter-1: Call, Service Type: Parameter-2: Mechanic, and Filter: Parameter-3: State Route 4, California. By using the extracted parameters from the natural language query, the query engine 120 generates the structural query to retrieve the plurality of results from the information source 300 available within the electronic device 100 or at the remote location within the server 200. The generated structural query is sent to the information source 300 by the query engine 120. In response to sending of the structural query, the query engine 120 receives the plurality of results. The query engine 120 selects only one candidate result which is more appropriate to the structural query and based on the degree of relevance (for example: near to the location of the electronic device 100). After selecting the candidate result, the candidate result related to the phone number field is extracted and call is automatically initiated and established using the phone application as shown in the FIG. 18.

Unlike conventional systems and methods, the proposed method is highly useful in situations where the user does not have access to the contact information such as the phone number, the email identifier, the message identifier etc. for various service providers. Such services include restaurant, school, mechanic, plumber, electrician, etc. Unlike conventional systems and methods, the proposed method provides that the action to be performed based on one single candidate result, which remains vital especially in case of emergency situations.

In an embodiment, the proposed method can be extended by involving learning models. The query engine 120 can be made to learn operation types and corresponding actions to be performed i.e., “Learn XYZ” and user specifies what service he/she means for “XYZ”. In an example, if the user provides the natural language query “Connect Wi-Fi”, then the query engine 120 automatically triggers for connecting to a best signal strength Wi-Fi connection. In another example, if the user provides the natural language query “Share Bluetooth” then, the query engine 120 automatically triggers for connecting to the nearest Bluetooth device and share a certain selected file. In another example, a useful speech trigger (i.e., natural language query) “Help” can initiate the call to the user selected emergency contact. In an embodiment, consider a scenario in which the user provides the natural language query such as:

“Connect <pause> Fi Network <pause> Wi Fi<pause> Low Traffic”

In this step, the query engine 120 recognizes and identifies the parameters and tags them for further query generation. In an example, the parameters are tagged as Operation Type: Parameter-1: Connect, Service Type: Parameter-2: Fi Network, Filter-1: Parameter-3: Wi-Fi, and Filter-2: Parameter-4: Low Traffic.

Further, the intermediary party accesses the information related to traffic level connected to each partner Wi-Fi routers. The authenticating information for connection with the Wi-Fi network having lowest traffic is sent to the user. Further, the electronic device 100 is connected to the Wi-Fi provider having the lowest traffic automatically using the sent information by the intermediary party. In networking, following measures are often considered important as described below:

1. Bandwidth: commonly measured in bits/second is the maximum rate that information can be transferred

2. Throughput: throughput is the actual rate that information is transferred

3. Latency: the delay between the sender and the receiver decoding it, this is mainly a function of the signals travel time, and processing time at any nodes the information traverses

4. Error rate: the number of corrupted bits expressed as a percentage or fraction of the total sent

Thus, these all can be possible filters by which user can issue the command to the Fi network while selecting the network provider. The user can specify such filters as and when required as per the user scenarios. Thus, such a system has following impacts as described below:

1. User control on the network provider to be connected through performance parameters, and

2. Enhance the flexibility and scalability of project Fi, as now user is not restricted to get connected only to the faster network provider.

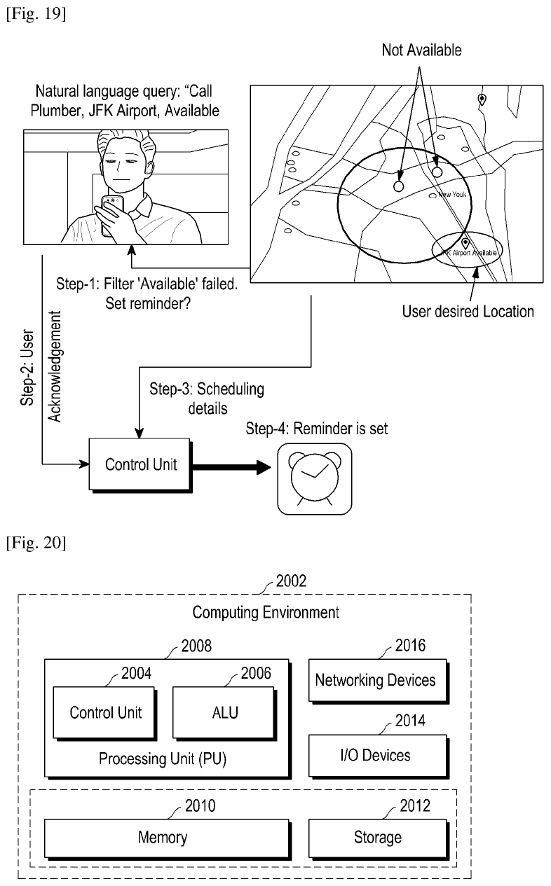

FIG. 19 is an example scenario for an electronic device set a reminder a response to a natural language query, according to an embodiment as disclosed herein. The process is initiated when the user provides the natural language query “Call Plumber, JFK Airport, Available” as the voice input to the electronic device 100 as shown in the FIG. 19. The user provides following voice input with the pause in between the parameters i.e.,

“Call <pause> Plumber <pause> JFK Airport <pause> Available”

After receiving the natural language query, the query engine 120 in the electronic device 100 extracts the plurality of parameters based on the techniques such as the NLP technique and splits the natural language query into various parameters such as Parameter-1: Call, Plumber-2: Plumber, Parameter-3: JFK Airport, and Parameter-4: Available

Further, the query engine 120 tags the parameters for further query generation. The parameters are tagged as Operation Type: Parameter-1: call, Service Type: Parameter-2: Plumber, First Filter: Parameter-3: JFK Airport, and Second Filter: Parameter-4: Available. By using the extracted parameters from the natural language query, the query engine 120 generates the structural query to retrieve the plurality of results from the information source 300 available within the electronic device 100 or at the remote location within the server 200. The generated structural query is sent to the information source 300 by the query engine 120. In response to sending the structural query, the query engine 120 determines two services (i.e., results) in the zone “JFK Airport”. However, none of these results are available and the filer “Available” is failed (Step-1). Once the filter “Available” is failed, the user intends to set the reminder for the same (Step-2). On receiving a request to set the reminder from the user, the electronic device 100 receives the scheduling details (Step-3) from the information source 300 and the reminder is set (Step-4) as shown in the FIG. 19.

FIG. 20 illustrates a computing environment implementing a method for managing the communication to perform an action by an electronic device, according to an embodiment as disclosed herein. The computing environment 2002 comprises at least one processing unit 2008 that is equipped with a control unit 2004 and an Arithmetic Logic Unit (ALU) 2006, a memory 2010, a storage unit 2012, plurality of networking devices 2016 and a plurality Input output (I/O) devices 2014. The processing unit 2008 is responsible for processing the instructions of the technique. The overall computing environment 2002 can be composed of multiple homogeneous or heterogeneous cores, multiple CPU (central processing unit)s of different kinds, special media and other accelerators. The processing unit 2008 is responsible for processing the instructions of the technique. Further, the plurality of processing units 2008 may be located on a single chip or over multiple chips. The technique comprising of instructions and codes required for the implementation are stored in either the memory unit 12010 or the storage 2012 or both. In case of any hardware implementations various networking devices 2016 or external I/O devices 2014 may be connected to the computing environment to support the implementation through the networking unit and the I/O device unit. The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for managing an action of an electronic device, the method comprising:
obtaining a structural query generated based on a natural language query including at least one parameter;
sending the structural query to at least one information source;
retrieving at least one result corresponding to the structural query from the at least one information source;
selecting a result from the at least one result; and
performing an action corresponding to the selected result as a response to the natural language query.

2. The method of claim 1, the method further comprising:
receiving the natural language query including the at least one parameter from a user;
extracting the at least one parameter from the natural language query; and
generating the structural query based on the extracted at least one parameter.

3. The method of claim 1, wherein the at least one result comprises at least one service provider, and
wherein selecting the result comprises:
selecting a service provider among the at least one result based on a service type included in the structural query; and
selecting contact information, as the result, among at least one contact of the selected service provider based on an action type included in the structural query.

4. The method of claim 3, wherein the at least one service provider is selected further based on at least one filter included in the structural query.

5. The method of claim 3, further comprising:
adjusting the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

6. The method of claim 1, wherein the action comprises one of opening an application, filling data in an application, terminating an application, composing a message, sending a message, displaying the candidate result, initiating a communication service, terminating a communication service, and updating a service,
wherein the at least one parameter comprises at least one of a desired location, a communication service request, a required action type, a required service type, a price, a user rating, an availability of a communication service, a satisfaction level of the user, congestion, throughput, latency, and a user defined parameter, and
wherein the selected result is one of a contact item, a service, an application, a message identifier, a web site address, a phone number, an e-mail identifier, a geographical address, a geographical location, and a social networking site (SNS) identifier.

7-8. (canceled)

9. An electronic device comprising:
a memory; and
at least one processor coupled to the memory,
wherein the at least one processor is configured to:
obtain a structural query generated based on a natural language query including at least one parameter,
send the structural query to at least one information source,
retrieve at least one result corresponding to the structural query from the at least one information source,
select a result from the at least one result, and
perform an action corresponding to the selected result as a response to the natural language.

10. A method for providing information by a server, the method comprising:
obtaining a structural query generated based on a natural language query including at least one parameter;
retrieving at least one result corresponding to the structural query from at least one information source;
selecting a result from the at least one result; and
transmitting the selected result for an electronic device to perform an action corresponding to the selected result as a response to the natural language query.

11. The method of claim 10, wherein the at least one result comprises at least one service provider, and
wherein selecting the result comprises:
selecting a service provider among the at least one result based on a service type included in the structural query; and
selecting contact information, as the result, among at least one contact of the selected service provider based on an action type included in the structural query,
wherein the at least one service provider is selected further based on at least one filter included in the structural query.

12. (canceled)

13. The method of claim 11, further comprising:
adjusting the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

14. The method of claim 10, wherein the at least one parameter comprises at least one of a desired location, a communication service request, a required action type, a required service type, a price, a user rating, an availability of a communication service, a satisfaction level of the user, congestion, throughput, latency, and a user defined parameter.

15. A server comprising:
a memory; and
at least one processor coupled to the memory,
wherein the at least one processor is configured to:
obtain a structural query generated based on a natural language query including at least one parameter;
retrieve at least one result corresponding to the structural query from at least one information source;
select a result from the at least one result; and
transmit the selected result for an electronic device to perform an action corresponding to the selected result as a response to the natural language query.

16. The electronic device of claim 9, wherein the at least one processor is further configured to:
receive the natural language query including the at least one parameter from a user,
extract the at least one parameter from the natural language query, and
generate the structural query based on the extracted at least one parameter.

17. The electronic device of claim 9, wherein the at least one result comprises at least one service provider, and
wherein the at least one processor is configured to select the result from the at least one result by:
selecting a service provider among the at least one result based on a service type included in the structural query; and
selecting contact information, as the result, among at least one contact of the selected service provider based on an action type included in the structural query.

18. The electronic device of claim 17, wherein the at least one service provider is selected further based on at least one filter included in the structural query.

19. The electronic device of claim 17, wherein the at least one processor is further configured to:
adjust the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

20. The electronic device of claim 9, wherein the action comprises one of opening an application, filling data in an application, terminating an application, composing a message, sending a message, displaying the candidate result, initiating a communication service, terminating a communication service, and updating a service,
wherein the at least one parameter comprises at least one of a desired location, a communication service request, a required action type, a required service type, a price, a user rating, an availability of a communication service, a satisfaction level of the user, congestion, throughput, latency, and a user defined parameter, and
wherein the selected result is one of a contact item, a service, an application, a message identifier, a web site address, a phone number, an e-mail identifier, a geographical address, a geographical location, and a social networking site (SNS) identifier.

21. The server of claim 15, wherein the at least one result comprises at least one service provider, and
wherein the at least one processor is configured to select the result from the at least one result by:
selecting a service provider among the at least one result based on a service type included in the structural query; and
selecting contact information, as the result, among at least one contact of the selected service provider based on an action type included in the structural query,
wherein the at least one service provider is selected further based on at least one filter included in the structural query.

22. The server of claim 21, wherein the at least one processor is further configured to:
adjust the structural query by modifying at least one parameter included in the structural query, if no result is retrieved from the at least one information source, if there are a plurality of candidates of the service provider, if there is no candidate of the service provider, if there are a plurality of candidates of the contact information, or if there is no candidate of the contact information.

23. The server of claim 15, wherein the at least one parameter comprises at least one of a desired location, a communication service request, a required action type, a required service type, a price, a user rating, an availability of a communication service, a satisfaction level of the user, congestion, throughput, latency, and a user defined parameter.
